(19) United States
(12) Patent Application Publication
(10) Pub. No.: US 2012/0040753 A1
(43) Pub. Date: Feb. 16, 2012

(54) ELECTRONIC GAME APPARATUS

(75) Inventors: PO-WEN HSIAO, HSINCHU (TW); KAI-CHENG CHUANG, HSINCHU (TW)

(73) Assignee: E Ink Holdings Inc., Hsinchu City (TW)

(21) Appl. No.: 13/091,315

(22) Filed: Apr. 21, 2011

(30) Foreign Application Priority Data
Aug. 16, 2010 (TW) 099127327

(51) Int. Cl. A63F 13/00; A63F 13/06

(52) U.S. Cl. 463/30; 463/37

(57) ABSTRACT

An electronic game apparatus comprises a plurality of electronic paper cards and a control device. Each of the electronic paper cards is configured for displaying an image. The control device comprises a control interface configured for a user to select a desired game mode. The control device is capable of changing the image displayed by at least one electronic paper card according to the selected game mode.

### FIELD OF THE INVENTION

The present invention relates to a game apparatus and, more particularly, to an electronic game apparatus.

### BACKGROUND OF THE INVENTION

A deck of traditional playing cards or jigsaw puzzles employs paper or plastic film as a pattern carrier. Once printed, the pattern can not be changed. Therefore, if customers get tired of the bought playing cards or the jigsaw puzzles, they have to buy another deck.

However, this results in a shortcoming. That is, customers have to frequently buy new decks of playing cards or jigsaw puzzles. Additionally, discarded decks are a waste of money and easily pollute environment.

### SUMMARY OF THE INVENTION

The object of the present invention is to provide an electronic game apparatus.

The present invention provides an electronic game apparatus, which comprises a plurality of electronic paper cards and a control device. Each of the electronic paper cards is configured for displaying an image. The control device comprises a control interface configured for customers to select a desired game mode. The control device is capable of changing the image displayed by at least one electronic paper card according to the selected game mode.

In a preferred embodiment of the present invention, each of the electronic paper cards is an electrophoretic display.

In a preferred embodiment of the present invention, the control interface is a touch-control interface or a mechanical push-button control interface.

In a preferred embodiment of the present invention, the control device further comprises an identification unit. The identification unit is configured for identifying a serial number of each of the electronic paper cards, so that the control device can change the image displayed by the said at least one electronic paper card according to the serial number. Preferably, the identification unit identifies the serial numbers with optical identification technology or radio frequency identification technology.

In a preferred embodiment of the present invention, each of the electronic paper cards further comprises a storage unit for storing a plurality of images corresponding to different game modes, so that the control device can change the image according to the selected game mode.

The electronic game apparatus of the present invention is constructed with a control device and a plurality of electronic paper cards, and the control device comprises a control interface for a user to select a desired game mode. The electronic paper cards are used as patterns carriers, and the control unit can change image displayed by the electronic paper cards according to the selected game mode. Therefore, the user can easily change game mode with the control device, so as to change the game. Hence, the user does not need to frequently buy new decks of playing cards or jigsaw puzzles, and the shortcoming aforementioned is overcome.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram of an electronic game apparatus in accordance with an exemplary embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

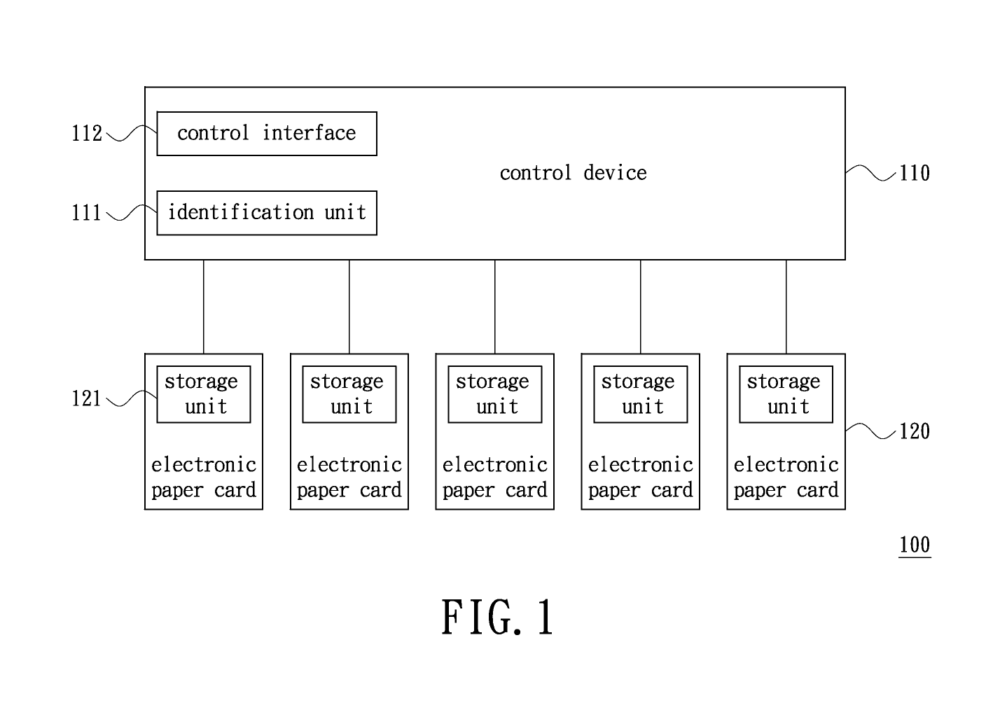

Referring to FIG. 1, an electronic game apparatus in accordance with an embodiment of the present invention is shown. As illustrated in FIG. 1, the electronic game apparatus 100 comprises a control device 110 and a plurality of electronic paper cards 120. Each of the electronic paper cards 120 is configured for displaying an image and is in cable or wireless connection with the control device 110. The control device 110 comprises a control interface 112 for a user to select a desired game mode. The control device 110 is capable of changing the image displayed by at least one electronic paper card 120 according to the selected game mode. In other words, the control device 110 is capable of changing the images displayed by a number of the electronic paper cards according to the needed number of the electronic paper cards in the selected game mode.

In the present embodiment, each of the electronic paper cards 120 can be an electrophoretic display to display an image such as a pattern of one of playing cards or jigsaw puzzles. Since the eletrophoretic display is bistable, it is capable of keeping on displaying an image until the image is updated. Additionally, the control interface 112 can be a touch-control interface or a mechanical push-button control interface.

Referring to FIG. 1, the control device 110 can further comprise an identification unit 111. The identification unit 111 is configured for identifying the serial numbers of the electronic paper cards 120. For example, the identification unit 111 can identify the serial numbers with optical identification technology or radio frequency identification technology, so that the control device 110 can change an image displayed by at least one electronic paper cards 120 accordingly.

Referring to FIG. 1, each of the electronic paper cards 120 can further comprise a storage unit 121 as well. The storage unit 121 is configured for storing a plurality of images corresponding to different game modes, so that the control device 110 can change the images according to the selected game mode. In other words, when connected with the electronic paper cards 120, the control device 110 can control the electronic paper cards 120 to display the images prestored in the storage unit 121 according to the selected game mode and the serial numbers of the electronic paper cards 120.

In summary, the electronic game apparatus of present invention is constructed with a control device and a plurality of electronic paper cards, and the control device comprises a control interface configured for a user to select a desired game mode. The electronic paper cards are used as pattern carriers, and the control unit is capable of changing images displayed by the electronic paper cards according to the selected game mode. Therefore, the user can easily change the game mode with the control device, so as to change the game. Hence, the user does not need to frequently buy new decks of playing cards or jigsaw puzzles, and the shortcoming aforementioned is overcome.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic game apparatus, comprising:
a plurality of electronic paper cards, each of the electronic paper cards being configured for displaying an image; and
a control device comprising a control interface, the control interface being configured for a user to select a desired game mode, the control device being capable of changing the image displayed by at least one electronic paper card according to the selected game mode.

2. The electronic game apparatus according to claim 1, wherein each of the electronic paper cards is an electrophoretic display.

3. The electronic game apparatus according to claim 1, wherein the control interface is a touch-control interface.

4. The electronic game apparatus according to claim 1, wherein the control interface is a mechanical push-button control interface.

5. The electronic game apparatus according to claim 1, wherein the control device further comprising an identification unit for identifying a serial number of each of the electronic paper cards, so that the control device is capable of changing the image displayed by the said at least one electronic paper card accordingly.

6. The electronic game apparatus according to claim 5, wherein the identification unit identifies the serial numbers of the electronic paper cards with optical identification technology.

7. The electronic game apparatus according to claim 5, wherein the identification unit identifies the serial numbers of the electronic paper cards with radio frequency identification technology.

8. The electronic game apparatus according to claim 1, wherein each of the electronic paper cards further comprises a storage unit, the storage unit is configured for storing a plurality of images corresponding to different game modes, so that the control device is capable of changing the images displayed by the said electronic paper cards according to the selected game mode.
